(19) United States
(12) Patent Application Publication
(10) Pub. No.: US 2021/0116573 A1
(43) Pub. Date: Apr. 22, 2021

(54) METHOD FOR OPERATING A CORRECTION SERVICE SYSTEM, CORRECTION SERVICE SYSTEM, METHOD FOR OPERATING A SATELLITE-BASED NAVIGATION SYSTEM, AND SATELLITE-BASED NAVIGATION SYSTEM

(71) Applicant: Robert Bosch GmbH, Stuttgart (DE)

(72) Inventors: Jens Strobel, Freiberg Am Neckar (DE); Marcus Langer, Asperg (DE)

(21) Appl. No.: 16/463,418

(22) PCT Filed: Feb. 22, 2018
(86) PCT No.: PCT/EP2018/054452

§ 371 Date: May 23, 2019

(30) Foreign Application Priority Data
Apr. 12, 2017 (DE) 10 2017 206 262.2

(51) Int. Cl. G01S 19/07; G01S 19/42

(52) U.S. Cl. CPC G01S 19/072; G01S 19/073; G01S 19/426

(57) ABSTRACT

For operating a correction service system for a satellite-based navigation system that is configured to determine a position of user devices, where the correction service system includes a plurality of reference stations having known and fixed coordinates and a plurality of receivers, a method includes operating a first group of the reference stations and the plurality of receivers, ascertaining a first correction value based on the satellite signals received by the first group of reference stations and their coordinates, ascertaining a second correction value based on the signals received by the plurality of receivers, ascertaining, based on the first and second correction values, a third correction value that is provided to the user devices.

### CROSS-REFERENCE TO RELATED APPLICATIONS

The present application is the national stage of International Pat. App. No. PCT/EP2018/054452 filed Feb. 22, 2018, and claims priority under 35 U.S.C. § 119 to DE 10 2017 206 262.2, filed in the Federal Republic of Germany on Dec. 12, 2016, the content of each of which are incorporated herein by reference in their entireties.

### FIELD OF THE INVENTION

The present invention relates to a method for operating a correction service system and to a correction service system. In addition, the present invention relates to a method for operating a satellite-based navigation system and to a satellite-based navigation system.

### BACKGROUND

Global navigation satellite systems (GNSS) make it possible to determine a position of a user device, such as a navigation unit, in a coordinate system. In the process, propagation times of received satellite signals of satellites of the global navigation satellite system are ascertained using the user device, and distances between the respective satellites and the user device are derived therefrom. The speed of light is normally assumed as the transmission speed of the satellite signals. If disturbances occur during the transmission, for instance as a result of certain conditions in the ionosphere or the troposphere, then changes in the propagation times, among others, are encountered, which can cause errors in the position determination. To take such disturbances into account, correction services are known, which use an existing network of stationary reference stations to ascertain correction values as a function of the received satellite signals and known coordinates of the respective reference station, and then make these correction values available to user devices. Errors of the described type in the position determination of the user devices are meant to be corrected using the correction values. However, it has become apparent that due to an insufficient density of the network of reference stations, ionospheric and/or tropospheric disturbances, in particular, are regionally not detectable or only partially detectable and not able to be considered in correction values. The detection of such disturbances that are currently not detected or only partially detected could be realized by a greater density of the existing network of reference stations. However, this would entail an enormous expense and is therefore not economically feasible.

### SUMMARY

An objective of the present invention is to provide a method for operating a correction service system, a correction service system, a method for operating a satellite-based navigation system, and a satellite-based navigation system, which do not give rise to the mentioned disadvantages. This objective is achieved by providing, for example, a method for operating a correction service system for a satellite-based navigation system that is configured to determine a position of user devices, where the correction service includes a plurality of reference stations having known and fixed coordinates in a coordinate system. A first group of the plurality of reference stations and a plurality of receivers of the correction service system are operated in order to receive satellite signals from a plurality of satellites of the satellite-based navigation system. At least one first correction value is ascertained as a function of the satellite signals received by the reference stations of the first group of the plurality of reference stations and as a function of the known coordinates of the respective reference station of the first group of the plurality of reference stations. For example, the first group of the plurality of reference stations is checked for a deviation between coordinates determined using the received satellite signals and the known coordinates of the respective reference station, and the at least one first correction value is ascertained as a function of a detected deviation. Such a deviation preferably describes a deviation that specifically leads to a significantly faulty coordinate ascertainment on the basis of the received satellite signals of the respective reference station. Within the framework of the method according to the present invention, at least one second correction value is ascertained using the satellite signals received by the plurality of receivers. At least one third correction value is then ascertained as a function of the at least one first and the at least one second correction value. The at least one third correction value is then made available to the user devices of the satellite-based navigation system. The present invention has advantages over the related art. Because the at least one third correction value is ascertained as a function of the at least one first and the at least one second correction value and made available to user devices of the satellite-based navigation system, it is possible to detect disturbances in the transmission of the satellite signals that were heretofore not detected or only partially detected, in particular on account of an insufficient density of an existing network of reference stations, and to specify correction values so that these disturbances can be taken into account during a position determination of the user devices. Thus, no increase in density of the existing network of reference stations is required, which avoids corresponding costs. In the final analysis, a more precise position determination and navigation of user devices, in particular of navigation units in motor vehicles or other mobile devices, is possible.

The at least one first correction value is therefore ascertained in particular when it is required for a correct position determination in accordance with a proper use of the correction service system. The ascertainment of the at least one first correction value is preferably carried out using a data processor of the correction service system. Using the at least one first correction value, respective clock errors of the plurality of satellites, respective path data errors of the plurality of satellites, and/or certain conditions in the ionosphere that adversely affect the transmission of the satellite signals are preferably corrected. Using the at least one second correction value, respective clock errors of the plurality of satellites, respective path data errors of the plurality of satellites, certain conditions in the ionosphere, and/or certain conditions in the troposphere that adversely affect the transmission of the satellite signals are preferably corrected. Preferably, the at least one first and the at least one second correction value are combined, the at least one first and the at least one second correction value preferably having parameters that are compatible with each other. Therefore, at least one third correction value is preferably ascertained by combining the at least one first and the at least one second correction value. It is preferably provided to use the at least one third correction value to correct respective clock errors of the plurality of satellites, respective path data errors of the plurality of satellites, and certain conditions in the ionosphere and/or certain conditions in the troposphere that adversely affect the transmission of the satellite signals. The ascertainment of the at least one third correction value is preferably carried out using a data processor of the correction service system, the at least one first and the at least one second correction value being supplied to the data processor. The at least one third correction value is then preferably provided to the user devices of the satellite-based navigation system.

According to the method for operating a satellite-based navigation system described in greater detail in the following text, the at least one third correction value is preferably ascertained using the user devices. The user devices are then preferably utilized to ascertain the at least one third correction value in order to determine the respective ego-position. The user devices then preferably make the ascertained at least one third correction value available to other user devices. In this case, the at least one first and the at least one second correction value are preferably provided to the user devices, the user devices ascertaining the at least one third correction value as a function of the at least one first and the at least one second correction value.

According to an example embodiment of the present method, inconsistencies in the course of the transmission of the satellite signals caused by certain conditions in the ionosphere or the troposphere, most preferably in the ionosphere and the troposphere, are corrected using the at least one second correction value. Alternatively or additionally, preferably using the at least one third correction value, inconsistencies in the course of the transmission of the satellite signals caused by certain conditions in the ionosphere or the troposphere, most preferably in the ionosphere and the troposphere, are corrected. A correction of such inconsistencies is particularly carried out in order to realize a more precise position determination for the user devices. Considering the ascertained conditions in the ionosphere and/or the troposphere improves the quality of the position determination by the user devices in the satellite-based navigation system and increases their reliability.

Preferably, receivers of a first group of the plurality of receivers, which are developed as a hardware- and/or software-based correction device of the correction service system allocated to a user device in each case, are controlled to monitor the received satellite signals for an unexpected satellite signal. When an unexpected satellite signal is detected, an item of information pertaining to the unexpected satellite signal will then preferably be generated. Taking the information into account, the at least one second correction value is then preferably ascertained. Alternatively or additionally, the at least one second correction value is preferably ascertained taking into account only the received satellite signals that are received by the respective receivers of the first group of the plurality of receivers developed as a correction device in each case. For communications purposes, the correction devices are preferably connected to the respectively allocated user device. It is furthermore preferred that at least one of the correction devices is integrally developed with the respectively allocated user device. The interplay between the correction device and the respectively allocated user device is developed in the following way, in particular. Using the correction device, input data of the previously described type are provided, that is to say, in particular the information and/or the received satellite signals, as a function of which the at least one second correction value and, finally, the at least one third correction value are ascertained, preferably using a data processor. The at least one third correction value is then made available to the allocated and/or the further user devices. Using the user device, it is particularly provided to determine the respective ego-position as a function of received satellite signals of the plurality of satellites and the received at least one third correction value. Preferably, either the user device or the allocated correction device receives satellite signals, or the user device and the allocated correction device receive satellite signals. Preferably utilizing a provided communications link that is provided between the user device and the allocated correction device, in particular, it is possible to forward the received satellite signals to the respective other of these devices, in particular, so that it is sufficient if only one of these two devices receives satellite signals.

Within the framework of the satellite-based navigation system described in the further text, the user devices are preferably developed as a navigation unit in a motor vehicle, a mobile telephone, a tablet computer, a wearable, a mobile unit, or in some other form in each case.

An unexpected satellite signal of the mentioned type particularly is a faulty, inconsistent, or an at least partially missing satellite signal. The generation of the information in connection with the unexpected satellite signal is preferably carried out using the correction devices, and the ascertainment of the at least one second correction value is preferably carried out under consideration of the information using the correction devices and, additionally or alternatively, using a data processor of the correction service system, developed as a central data processor, in particular. Alternatively or additionally, the generation of the information concerning the unexpected satellite signal is preferably accomplished using a data processor of the correction service system implemented as a central data processor, in particular; the ascertainment of the at least one second correction value is preferably realized using the data processor of the correction service system developed as a central data processor, in particular, and under consideration of the information. Alternatively or additionally, the at least one second correction value is preferably ascertained taking the received satellite signals into account; more specifically, the monitoring of the received satellite signals for an unexpected satellite signal and the generation of the information concerning the unexpected satellite signal will not be carried out when an unexpected satellite signal is detected. The at least one second correction value is preferably carried out using the correction devices, taking the received satellite signals into account. Alternatively or additionally, the at least one second correction value is preferably implemented under consideration of the received satellite signals and using a data processor of the correction service system developed as a central data processor, in particular. As a result, it is advantageously possible to ascertain the at least one second correction value using a multitude of correction devices, in particular, thereby making it possible to improve the quality of the at least one second correction value.

Preferably, the at least one second correction value is ascertained as a function of the satellite signals received by receivers of a second group of the plurality of receivers, each being developed as a reference station of a second group of the plurality of reference stations, and as a function of known, in particular fixed, coordinates of the respective receivers of the second group of the plurality of receivers. The second group of the plurality of receivers preferably differs at least partially from the first group of the plurality of receivers. The second group of the plurality of reference stations preferably differs at least partially from the first group of the plurality of reference stations. Preferably, the at least one second correction value is ascertained using a data processor of the correction service system. For example, the receivers of the second group of the plurality of receivers are checked for a deviation between coordinates received using the received satellite signals and the known coordinates of the respective receivers, and the at least one second correction value is ascertained as a function of a detected deviation. More specifically, such a deviation is a deviation that particularly requires the ascertainment of the at least one second correction value for a correct position determination in accordance with an appropriate use of the correction service system. This makes it possible to increase the density, in particular the local density, of an especially global network of reference stations of the first group of the plurality of reference stations in that the at least one second correction value is preferably ascertained using a data processor of the correction service system using reference stations of the second group of the plurality of reference stations. This improves the quality of the position determination of the user devices in the satellite-based navigation system.

Moreover, the at least one second correction value is preferably specified for satellite signals of one or more of the plurality of satellites. Alternatively or additionally, the at least one third correction value is specified for satellite signals of one or more of the plurality of satellites. This specifically makes it possible to easily realize a communications link between the correction service system and further systems that utilize the correction of a determined position by the correction service system, in particular.

Preferably, the at least one second correction value is made available to the user devices by at least one means, which is selected from a group made up of a communications satellite and a mobile telephony network. Alternatively or additionally, the at least one third correction value is provided to the user devices using at least one means, which is selected from a group made up of the communications satellite and the mobile telephony network. The communications satellite is preferably a satellite of the plurality of satellites of the satellite-based navigation system. As an alternative, the communications satellite differs from the plurality of satellites of the satellite-based navigation system. The use of existing resources, such as existing communications satellites or existing mobile telephony networks, thus particularly makes it possible to keep the costs of the method according to the present invention low.

According to an example embodiment of the present invention, a method for operating a satellite-based navigation system, which also provides the aforementioned advantages, is used for operating a satellite-based navigation system having a plurality of satellites, a plurality of user devices, and a correction service system, the correction service system including a plurality of reference stations having known and fixed coordinates in a coordinate system, and a plurality of receivers. A first group of the plurality of reference stations and a plurality of receivers of the correction service system are operated in order to receive satellite signals from a plurality of satellites of the satellite-based navigation system. At least one first correction value is ascertained as a function of the satellite signals received by the reference stations of the first group of the plurality of reference stations and the known coordinates of the respective reference station of the first group of the plurality of reference stations. Within the framework of this method, it is provided to carry out the method for operating a correction service system as described above.

Preferably, a correction service system of the type described in the following text is operated based on the described method for operating a correction service system.

An example embodiment of the present invention is directed to a correction service system that also provides the aforementioned advantages. The correction service system includes a plurality of reference stations having known and fixed coordinates and a plurality of receivers. The multiple receivers are preferably at least in part developed as hardware- and/or software-based correction devices, which particularly are allocated to an individual user device of a satellite-based navigation system. Alternatively or additionally, the multiple receivers are at least in part developed as reference stations of the correction service system. The correction service system is developed to carry out the described method for operating a correction service system. Toward this end, control units are provided, which in particular are programmed to carry out the described method and are preferably allocated to the respective device for the control of the plurality of reference stations and the plurality of receivers of the correction service system as described. In addition, control devices are available, which are programmed especially for carrying out the described method, and which are preferably allocated to the respective device for the described control of the at least one communications satellite, the at least one mobile telephony network, and/or a data processor of the correction service system. Control devices, which are programmed to carry out the described method, are preferably provided for the control of additional devices of the correction service system.

Preferably, a satellite-based navigation system of the type described in the following text is operated based on the described method for operating a satellite-based navigation system.

An example embodiment of the present invention is directed to a satellite-based navigation system that also provides the aforementioned advantages. The satellite-based navigation system has a plurality of satellites, user devices, and the described correction service system. The satellite-based navigation system is developed to carry out the described method for operating a satellite-based navigation system. Toward this end, control devices are provided, which in particular are programmed to carry out the described method, the control devices being allocated to the respective device, preferably for the control of the plurality of satellites, the user devices, and the correction service system of the satellite-based navigation system. Control devices are preferably provided which are programmed to carry out the described method for the control of additional devices of the satellite-based navigation system.

In the following text, the present invention will be described in greater detail with reference to the drawings.

### BRIEF DESCRIPTION OF THE DRAWINGS

FIG. 1 is a schematic illustration of a correction service system according to an example embodiment of the present invention.

FIG. 2 is a flowchart that illustrates a method for operating a correction service system, according to an example embodiment of the present invention.

### DETAILED DESCRIPTION

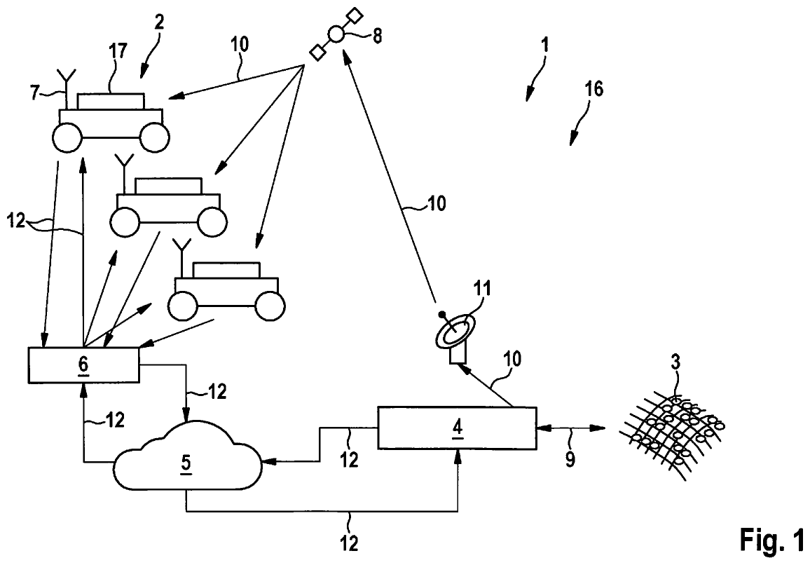

FIG. 1 shows an example embodiment of a correction service system 1. Correction service system 1 is part of a satellite-based navigation system 16 for determining a position of user devices in a coordinate system. In addition, satellite-based navigation system 16 includes such user devices 2. For reasons of clarity, only one of user devices 2 has been given a reference numeral. In this instance, user devices 2 are developed as a navigation unit in a motor vehicle by way of example. Satellite-based navigation system 16 additionally encompasses a plurality of satellites, which are not shown here.

Correction service system 1 includes a plurality of reference stations 3 having known and fixed coordinates, which are preferably situated in a network of reference stations 3. For better clarity, only one of reference stations 3 has been provided with a reference numeral. In addition, correction service system 1 has a plurality of receivers. The multiple receivers are preferably at least partially configured as hardware- and/or software-based correction devices 17, each being allocated to one of user devices 2. In the example embodiment shown here, correction devices 17 are integrally developed with a user device 2 and/or connected thereto in terms of communications technology. Alternatively or additionally, the multiple receivers are preferably at least partially developed as reference stations 3.

In the example embodiment shown here, correction service system 1 includes a data processor 4 and a backend server 5. More specifically, data processor 4 is developed as a central data processor 4 in this instance. In addition, correction service system 1 preferably has at least one—and in this case, exactly one—mobile telephony network 6. Correction devices 17 and preferably user devices 2 are linked to mobile telephony network 6 via a suitable transmission and receiving device 7 of correction devices 17. Alternatively, transmission and receiving device 7 is allocated to user devices 2. A connection of correction devices 17 and the respectively allocated user devices 2 to mobile telephony network 6 is preferably ensured on account of the preferably provided communications link between correction devices 17 and the respectively allocated user devices 2. In addition, correction service system 1 preferably includes at least one—and in this instance, exactly one—communications satellite 8.

In this example embodiment, a first communications link 9 is provided between the plurality of reference stations 3 and data processor 4, by way of which the plurality of reference stations 3 and data processor 4 are preferably connected in terms of communications technology. Using first communications link 9, preferably data and information of the plurality of reference stations 3 are transmittable to data processor 4. In addition, it is preferably possible to transmit data and information from data processor 4 to the plurality of reference stations 3. Moreover, a second communications link 10 is preferably provided between data processor 4 and user devices 2. More specifically, data processor 4 is in a communications connection with at least one—in this instance, exactly one—transmission station 11 of correction service system 1, transmission station 11 being able to communicate with communications satellite 8, and communications satellite 8 being able to communicate with user devices 2. Using second communications link 10, data and information are preferably transmittable from data processor 4 to user devices 2. In addition, a third communications link 12 is preferably provided between data processor 4 and correction devices 17 as well as user devices 2 in this example embodiment. More specifically, data processor 4 is connected to backend server 5 for communications purposes, backend server 5 is connected to mobile telephony network 6 for communications purposes, and mobile telephony network 6 is connected through a communications link via the respective transmission and receiving devices 7 to respective correction devices 17 and user devices 2. Using third communications link 12, data and information are preferably able to be transmitted, especially back and forth, between at least two devices which are selected from a group made up of data processor 4, backend server 5, mobile telephony network 6, transmission and receiving device 7, correction devices 17 and user devices 2.

Advantageous correction service system 1 is developed to carry out a method of the type described in the following text.

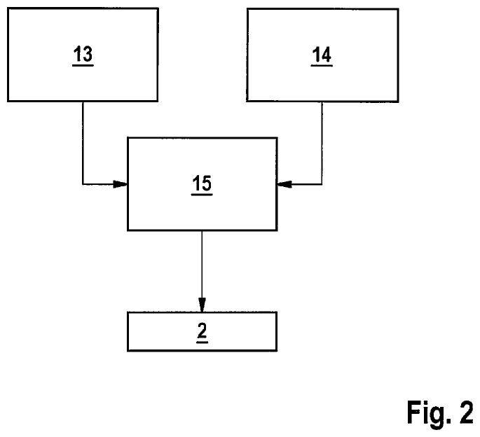

FIG. 2 schematically illustrates a method for operating advantageous correction service system 1 for satellite-based navigation system 16, which is configured to determine a position of user devices 2, the navigation system including a plurality of reference stations 3 in a coordinate system having a plurality of known and fixed coordinates. Identical or functionally equivalent elements have been provided with matching reference numerals so that reference is made to the previous description in this regard. Within the framework of the advantageous method, a first group of the plurality of reference stations 3 and a plurality of receivers of correction service system 1 are operated to receive satellite signals from a plurality of satellites of the satellite-based navigation system 16. At least one first correction value 13 is ascertained as a function of the satellite signals received by reference stations 3 of the first group of the plurality of reference stations 3, and as a function of the known coordinates of the respective reference station 3 of the first group of the plurality of reference stations 3. Using the satellite signals received by the plurality of receivers, at least one second correction value 14 will then be ascertained. At least one third correction value 15 is ascertained as a function of the at least one first correction value 13 and the at least one second correction value 14. The at least one third correction value 15 is then provided to user devices 2 of satellite-based navigation system 16.

Preferably, inconsistencies during the transmission of the satellite signals as a result of certain conditions in the ionosphere or the troposphere, most preferably in the ionosphere and the troposphere, are corrected using the at least one second correction value 14. Alternatively or additionally, inconsistencies during the transmission of the satellite signals as a result of certain conditions in the ionosphere or the troposphere, most preferably in the ionosphere and the troposphere, are corrected, preferably using the at least one third correction value 15.

It is preferably provided that receivers of a first group of the plurality of receivers, which are developed as a hardware- and/or software-based correction device 17 of correction service system 1 allocated to a user device 2 in each case, are controlled to monitor the received satellite signals for an unexpected satellite signal, and, when an unexpected satellite signal is detected, an item of information regarding the unexpected satellite signal is generated, and the at least one second correction value 14 is ascertained taking the item of information into account. Alternatively or additionally, the at least one second correction value 14 is preferably ascertained taking into account only the particular satellite signals that are received by the receivers of the first group of the plurality of receivers developed as a correction device 17 in each case.

The at least one second correction value 14 is preferably ascertained as a function of the satellite signals received by receivers of a second group of the plurality of receivers, which are developed as a reference station 3 of a second group of the plurality of reference stations, and as a function of known, preferably fixed coordinates of the respective receivers of the second group of the plurality of receivers. The second group of the plurality of receivers most preferably differs at least partially from the first group of the plurality of receivers. Most preferably, the second group of the plurality of reference stations 3 also differs at least partially from the first group of the plurality of reference stations 3.

In an example embodiment, the at least one second correction value 14 is specified for satellite signals from one or more satellites of the plurality of satellites in each case. Alternatively or additionally, the at least one third correction value 15 is preferably specified for satellite signals from one or more satellites of the plurality of satellites in each case.

The at least one second correction value 14 is made available to user devices 2 preferably using at least one means, which is selected from among a group made up of communications satellite 8 and mobile telephony network 6. Alternatively or additionally, the at least one third correction value 15 is made available to user devices 2 preferably using at least one means, which is selected from a group made up of communications satellite 8 and mobile telephony network 6.

A method of the afore-described type is preferably carried out within the framework of a method for operating a satellite-based navigation system 16 having a plurality of satellites, a plurality of user devices 2, and a correction service system 1, correction service system 1 including a plurality of reference stations having known and fixed coordinates in a coordinate system and a plurality of receivers. In the process, a first group of the plurality of reference stations 3 and the plurality of receivers of correction service system 1 are operated in order to receive satellite signals of a plurality of satellites of satellite-based navigation system 16. At least one first correction value 13 is ascertained as a function of the satellite signals received by reference stations 3 of the first group of the plurality of reference stations 3, and as a function of the known coordinates of the respective reference station 3 of the first group of the plurality of reference stations 3.

In summary, it has been shown that it is possible to realize a more precise position determination and navigation of user devices 2 in an effective and cost-advantageous manner using an advantageous method for operating correction service system 1 and using correction service system 1.

1-9. (canceled)

10. A method for operating a correction service system that includes a plurality of reference stations at fixed coordinates of a coordinate system and includes a plurality of receivers, the method comprising:
operating a first group of the plurality of reference stations and the plurality of receivers to receive satellite signals from a plurality of satellites of a satellite-based navigation system, wherein the satellite-based navigation system is configured to determine a position of user devices of the satellite-based navigation system;
ascertaining at least one first correction value based on (a) the satellite signals received by each of the reference stations of the first group of the plurality of reference stations and (b) the respective fixed coordinates of the first group of the plurality of reference stations;
ascertaining at least one second correction value based on the satellite signals received by the plurality of receivers;
ascertaining at least one third correction value based on the at least one first correction value and the at least one second correction value; and
outputting the at least one third correction value to the user devices.

11. The method of claim 10, wherein inconsistencies during transmission of the satellite signals as a result of at least one of ionospheric and tropospheric conditions are corrected using at least one of (a) the at least one second correction value and (b) the at least one third correction value.

12. The method of claim 10, wherein:
each receiver of a first group of the plurality of receivers is a correction device respectively allocated to a respective one of the user devices and is controlled to monitor the received satellite signals for an unexpected satellite signal, in response to which an item of information concerning the unexpected satellite signal is generated;
the at least one second correction value is ascertained based on the generated information concerning the unexpected satellite signal; and
the at least one second correction value is ascertained based only on the satellite signals received by the receivers of the first group of the plurality of receivers.

13. The method of claim 10, wherein the plurality of receivers on the basis of which the at least one second correction value is ascertained is a second group of the reference stations, all of the reference stations of which differ from the reference stations of the first group of the reference stations, and the at least one second correction value is further based on the fixed coordinates of the second group of the reference stations.

14. The method of claim 10, wherein each of at least one of the second and third correction values is a value by which a satellite signal from one or more of the satellites is corrected.

15. The method of claim 10, wherein the outputting is performed one or both of (a) a communications satellite and (b) a mobile telephony network.

16. A method for operating a satellite-based navigation system that includes a plurality of satellites, a plurality of user devices, and a correction service system, the correction service system including a plurality of reference stations at fixed coordinates of a coordinate system and a plurality of receivers, the method comprising:
operating a first group of the plurality of reference stations and the plurality of receivers to receive satellite signals from the plurality of satellites;
ascertaining at least one first correction value based on the satellite signals received by each of the reference stations of the first group of the plurality of reference stations and the respective fixed coordinates of the first group of the plurality of reference stations;
ascertaining at least one second correction value based on the satellite signals received by the plurality of receivers;
ascertaining at least one third correction value based on the at least one first correction value and the at least one second correction value; and
outputting the at least one third correction value to the user devices.

17. A correction service system comprising
a plurality of reference stations at fixed coordinates; and
a plurality of receivers;
wherein the correction service system is configured to perform a method, the method comprising:
operating a first group of the plurality of reference stations and the plurality of receivers to receive satellite signals from a plurality of satellites of a satellite-based navigation system, wherein the satellite-based navigation system is configured to determine a position of user devices of the satellite-based navigation system;
ascertaining at least one first correction value based on (a) the satellite signals received by each of the reference stations of the first group of the plurality of reference stations and (b) the respective fixed coordinates of the first group of the plurality of reference stations;
ascertaining at least one second correction value based on the satellite signals received by the plurality of receivers;
ascertaining at least one third correction value based on the at least one first correction value and the at least one second correction value; and
outputting the at least one third correction value to the user devices.

18. A satellite-based navigation system comprising:
a plurality of satellites;
user devices, wherein the satellite-based navigation system is configured to determine a position of user devices of the satellite-based navigation system; and
a correction service system that includes a plurality of reference stations at fixed coordinates and a plurality of receivers, wherein the correction service system is configured to perform a method, the method comprising:
operating a first group of the plurality of reference stations and the plurality of receivers to receive satellite signals from the plurality of satellites;
ascertaining at least one first correction value based on (a) the satellite signals received by each of the reference stations of the first group of the plurality of reference stations and (b) the respective fixed coordinates of the first group of the plurality of reference stations;
ascertaining at least one second correction value based on the satellite signals received by the plurality of receivers;
ascertaining at least one third correction value based on the at least one first correction value and the at least one second correction value; and
outputting the at least one third correction value to the user devices.
